(19) United States
(12) Patent Application Publication
(10) Pub. No.: US 2015/0144394 A1
(43) Pub. Date: May 28, 2015

(54) CABLE HOLDER

(71) Applicant: NEXT WAVE DESIGN PTY LTD, Biggera Waters Qld (AU)

(72) Inventor: Anthony Philip Webb, Biggera Waters Qld (AU)

(21) Appl. No.: 14/401,057

(22) PCT Filed: May 13, 2013
(86) PCT No.: PCT/AU2013/000482

§ 371 Date: Nov. 13, 2014

(30) Foreign Application Priority Data
May 14, 2012 (AU) 2012901951
Sep. 17, 2012 (AU) 2012904036
Oct. 2, 2012 (AU) 2012904279
Feb. 5, 2013 (AU) 2013900364

(51) Int. Cl. H02G 15/113; H02G 1/14; H02G 15/117

(52) U.S. Cl. CPC H02G 15/113; H02G 15/117; H02G 1/14
USPC 174/658

(57) ABSTRACT

A cable holder useful for holding a single insulated cable assembly or a multiplicity of insulated cable assemblies wherein the cable holder is formed by a pair of components attached to or integral with each other so as to form a sheath or sleeve for containing the cable assembly or cable assemblies. Adjacent metal ends of the adjoining cable parts are interconnected by a metal joint.

### FIELD OF THE INVENTION

This invention relates to a cable holder for use in holding or retaining one or more electrical cables wherein the cable holder is an insulating sleeve which insulates a bare metal joint formed by metal ends of adjacent insulated cables.

### BACKGROUND OF THE INVENTION

It has often been a problem in relation to electrical cables to prevent bare metal conductors from contacting each other when doing routine electrical repair work such as connecting adjacent ends of metal together or conductors. It will be appreciated that electrical cables or wires when damaged are fire hazards. Also electrocution may occur if a damaged electrical cable is touched. If electrical cable repairs are contemplated it is necessary to switch off all power sources such as by going to the circuit breaker or fuse box. It is then usual to cut an insulation layer off the metal cable so that each cable or conductor can be examined. If damage has occurred it is the usual practice to separate and repair each cable or conductor and wrap them individually with electrical tape. After that the damaged insulation layer usually formed from rubber or plastics material may also be covered with electrical tape. However the use of electrical tape in making repairs is dangerous because it may loosen or deteriorate over the passage of time.

An alternative procedure to the above is to cut the damaged sections of the wires and remove the rubber or plastics material covering surrounding each wire. The adjacent metal ends of adjoining wires are formed by inserting each end into a metal tube and each end is retained in a joined state by use of a grub screw. The joined or attached ends may then be enclosed in a plastics junction box. This procedure is time consuming and also dangerous because the grub screws may loosen over the passage of time due to, for example, expansion and contraction from heat cycles. It has often been proposed that a tubular sheath be used for housing bunched cables such as described in U.S. Pat. No. 5,905,231 wherein use is made of a clamp to attach adjacent side edges of the tubular sheath to each other.

In U.S. Pat. No. 4,865,890 it was proposed to provide a protective sleeve about an electrical cable which has opposed side edges connected by adjacent locking members which are formed of material that is more dimensionally stable upon exposure to air than the sleeve which shrinks upon exposure to air. Shrink-fit protective sleeves for electrical cables are also proposed in International Publication WO 96/19334 and U.S. Pat. No. 4,388,488.

In U.S. Pat. No. 6,240,967 there was proposed a protective sleeve assembly for preventing damage to a power cord providing alternating voltage and current to an electrical cutting implement during inadvertent contact between the edge of the blade of the cutting assembly and the power cord. The protective sleeve had a through wall slit that extended longitudinally the full length of the protective sleeve wherein the slit allows for easy insertion of the power cord and then opposing edges of the slit may be locked to each other by compressive interference. The first end of the sleeve may then be attached to the power cord.

U.S. Pat. No. 3,183,302 referred to a cover for an electrical connector having a pair of mating half sections hinged on a common side by integral webs that enabled each half section be moved from an open position to a closed position and a hook and loop arrangement was used for maintaining each half section in the closed position. The connector was used to join a pair of wires to each other which are initially joined to each other by a metal sleeve or splice by a crimping tool before the wires and metal sleeve joining the wires are located in the electrical connector which is made of electrically insulative material.

U.S. Pat. No. 4,970,351 referred to a wiring harness conduit having a corrugated tubular wall member of resilient plastic material and an outer covering of flexible sound deadening foamed material with an axial slit from end to end through the outer covering and the wall member.

In U.S. Pat. No. 5,217,387 there is described a hinged housing defining two openings which receive inserts to accommodate various sizes and shapes of electrical cords. Also disclosed is a sheath formed from rubber which is installed over an electrical connection between two electrical power cords before insertion of the connection in the housing. The sheath is for water proofing or sealing the electrical connection. A similar arrangement is described in U.S. Pat. No. 5,147,216.

U.S. Pat. No. 2,894,056 refers to a protective sheath for a cable connector which is formed of a pair of components releasably attachable to each other which encloses a metal splice connecting metal sections of two electrical power cords.

U.S. Pat. No. 3,344,393 describes a connector housing for connectors of extension cords comprising a pair of components hinged along a pair of adjacent side edges and hook shaped extension or latch engaging a mating rib or shelf when each component is in the closed position. There is also provided a pair of rubber blocks located at each end of the housing for sealing respective insulated power cords of each extension component.

U.S. Pat. No. 5,834,690 describes a waterproof safety case for a plug and receptacle of power cords which comprises a pair of components hinged along a pair of adjacent side edges. There are provided a pair of end portions of each component which each have labyrinth seals in a centre part for sealing a power cord associated with each of the plug and receptacle. There is also provided a continuous peripheral seal for each abutting side edge of each of the end portions wherein a rib or ledge of one component engages a rubber gasket of the other component. A similar sealing arrangement applies to each of the longitudinal free edges of each of the components. In the hinge strip at each end a small rubber square seals off each end of the hinge strip.

Both U.S. Pat. Nos. 4,869,683 and 7,137,843 describe a sealing sheath for electrical connectors having a zipper connecting adjacent longitudinal edges and a slide fastener respectively.

U.S. Pat. No. 5,299,451 describes a two part housing for extension cord components connected to each other wherein each of the two parts when connected to each other have a sealing gasket or O-ring and at each end of the housing there are provided compressible sealing bushings.

WO 9627222 describes a protective electrical coupling which encloses a plug and socket connection having a pair of components screw threadedly attached to each other. A sealing arrangement is provided wherein a sealing flange engages with a capillary groove. U.S. Pat. No. 5,306,176 describes a similar arrangement.

In summary of the prior art discussed above, it is evident that such connectors were complicated in structure. This is illustrated for example in the case of U.S. Pat. No. 3,183,302 wherein the electrical connector was provided with partitions adjacent each end which formed an internal compartment for housing the metal splice or sleeve. Each partition is spaced inwardly of an adjoining end wall of the electrical connector. However each partition could not prevent longitudinal movement of the metal splice or sleeve. To prevent this it was necessary for each end wall to be provided with a plurality of tabs. Thus the presence of the partitions and the tabs substantially increased manufacturing costs of the electrical connector. Also it was necessary for the metal splice or sleeve to be corrugated and having a substantially greater diameter than the diameter of the wires or associated insulated conductors.

Reference may be made to U.S. Pat. No. 4,935,582 which relates to an enclosure for sealing, insulating and strain relieving a conductor splice of insulated metal wires. A conductor splice refers to a metal joint for interconnecting adjacent ends of adjoining metal wires and thus may comprise a welded or soldered metal joint or alternatively the metal joint may be a crimped band. The metal joint is sealed or made waterproof by use of a mastic sealer which requires an outer layer of peelable paper wherein the mastic sealer is applied to each internal surface of the enclosure which receives the metal joint as well as each internal surface of internal passages which each receive an insulated wire. This method of sealing is labour intensive in that it requires removal of the outer layer of peelable paper and is also inefficient in use.

### SUMMARY OF THE INVENTION

The invention therefore provides in one aspect a cable holder useful for holding a single insulated cable assembly or a multiplicity of insulated cable assemblies wherein the cable holder is formed by a pair of components attached to or integral with each other so as to form a sheath or sleeve for containing the cable assembly or cable assemblies wherein adjacent metal ends of adjoining cable parts are interconnected by a metal joint which may include a crimped metal-sleeve or cable ends soldered to each other and when the holder is in a closed position there is provided an internal space formed by mutually adjoining channels. Preferably each internal space has a diameter or transverse dimension that is substantially the same as an insulated cable part located proximal to said metal joint.

Each component in this aspect may be provided with a sealing rib or gasket that completely surrounds an internal channel or plurality of internal channels whereby when the cable holder is in a closed position adjacent sealing ribs are in abutment with each other whereby each sealing rib is formed by an overmoulding process.

Each component may be integral with each other by a hinge such as a pivot rib or hinge joint or may be completely separate from each other and attachable thereto by various mechanisms including clips, plug and socket interaction or by interference fit or snap fit.

Each component may also form a half channel and when hinged to each other each free side edge of each of the components may be attached to each other by releasable attachment means as described above. Most preferably a longitudinal rib of one component may engage a mating longitudinal recess of the other component.

Each channel may be U shaped and the cable holder may have a pair of mating channels for retention of a single insulated cable assembly. Alternatively each channel may have a corrugated surface or each component has a plurality of channels whereby each mating channel holds a respective insulated cable assembly. This arrangement is ideally suited to electrical cables or wires each having a neutral (N), active (A) and earth (E) conductor.

Each sealing rib is preferably formed by overmoulding wherein the structure of each component may be formed initially by a moulding process such as injection moulding using rigid plastics material whereby a groove may be formed which is filled with a softer plastics material such as thermoplastic elastomers during a secondary moulding process.

Reference may be made to overmoulding techniques or processes that are described at www.glstpes.com/pdf/om.pdf in regard to the GLS Overmoulding Guide.

It will also be appreciated from the above that the cable holder of the invention will cover, insulate, support and weatherproof a metal joint between adjacent cables or wires in the most compact, economically effective, and non labour intensive manner.

In another embodiment of the invention reference is made to a cable holder which does not utilise the sealing rib or gasket formed by an overmoulding process. This aspect refers to a cable holder useful for holding a single cable which cable holder is formed by a pair of components attached to each other so as to form a sheath or sleeve for containing the cable wherein adjacent metal ends of adjoining cables are interconnected by a metal joint which may include a crimped metal sleeve or cable ends soldered or otherwise joined to each other and when the holder is in a closed position there is provided an internal space formed by mutually adjoining channels wherein the internal space has a diameter that is substantially the same as an insulated cable part located proximal to the said metal joint. Also the metal joint may have a diameter or lateral dimension smaller than a diameter or transverse dimension of the internal space.

Preferably each component in this aspect has a free edge so that adjacent free edges may be attached to each other by a plug and socket connection. There also may be provided a pair of mating substantially flat surfaces which bound the plug or the socket. In this regard the plug may comprise a round part and a support stem which is located intermediate the pair of substantially flat surfaces. Also the socket may have a substantially circular opening for retaining the round part in use and relatively narrow passage for retaining the support stem.

The cable holder in this aspect may also have a hinge part formed by a relatively thinner side wall part located substantially opposite to the plug and socket connection adjoining each of the free edges. The remainder of the side wall may be thicker than the thin part.

The cable holder may also be provided with at each end an inwardly extending rib which facilitates engagement with an adjacent insulated cable. In this regard the ends of the cable holder may be shrunk by heat and/or pressure moulding.

The cable holder may also have a discrete length so that it can be used for protection of the metal joint referred to above. Thus the cable holder is not used in applications which require a relatively long length.

### DESCRIPTION OF PREFERRED EMBODIMENTS OF THE INVENTION

Reference may be made to a preferred embodiment of a cable holder of the invention as shown in the attached drawings wherein:

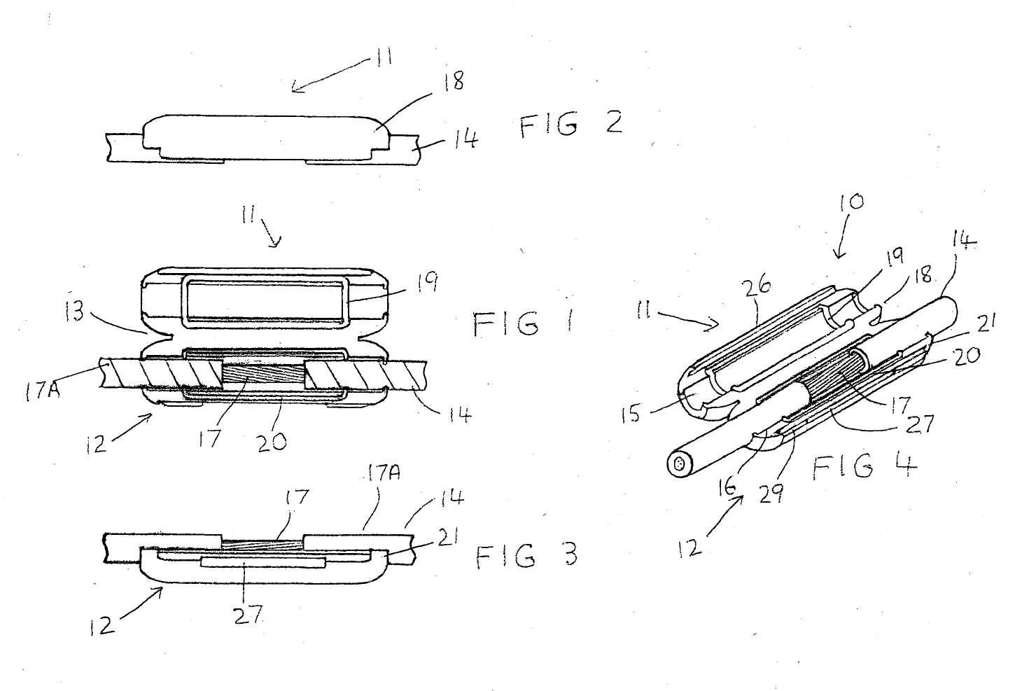

FIG. 1 is a plan view of a first embodiment of a cable holder of the invention;

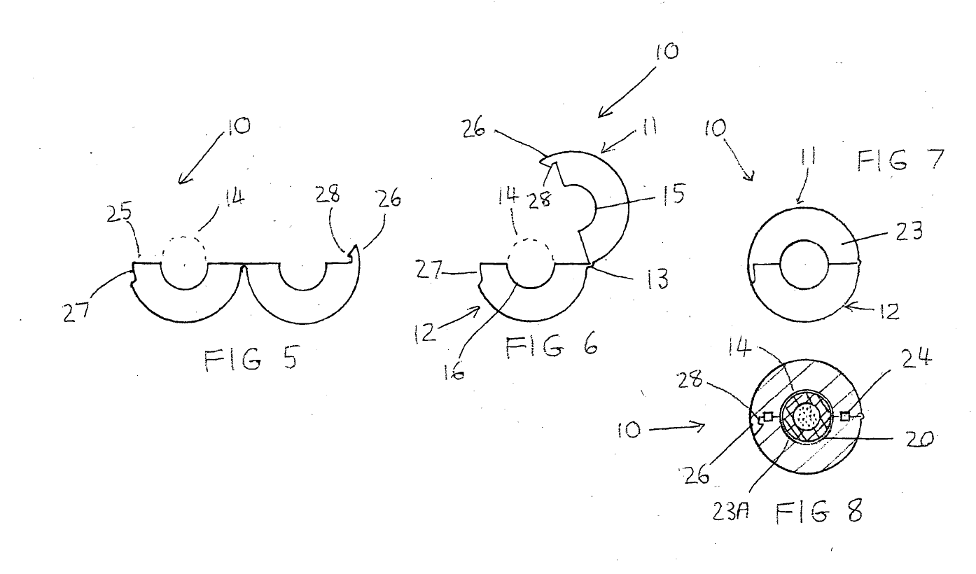

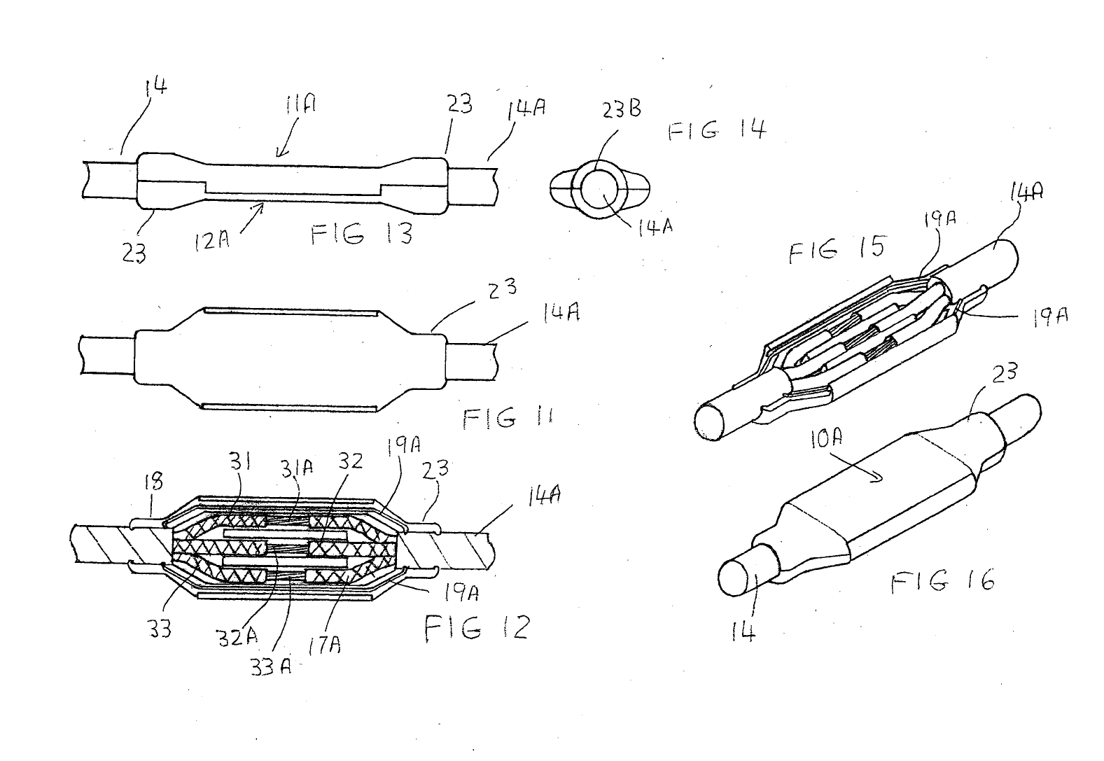

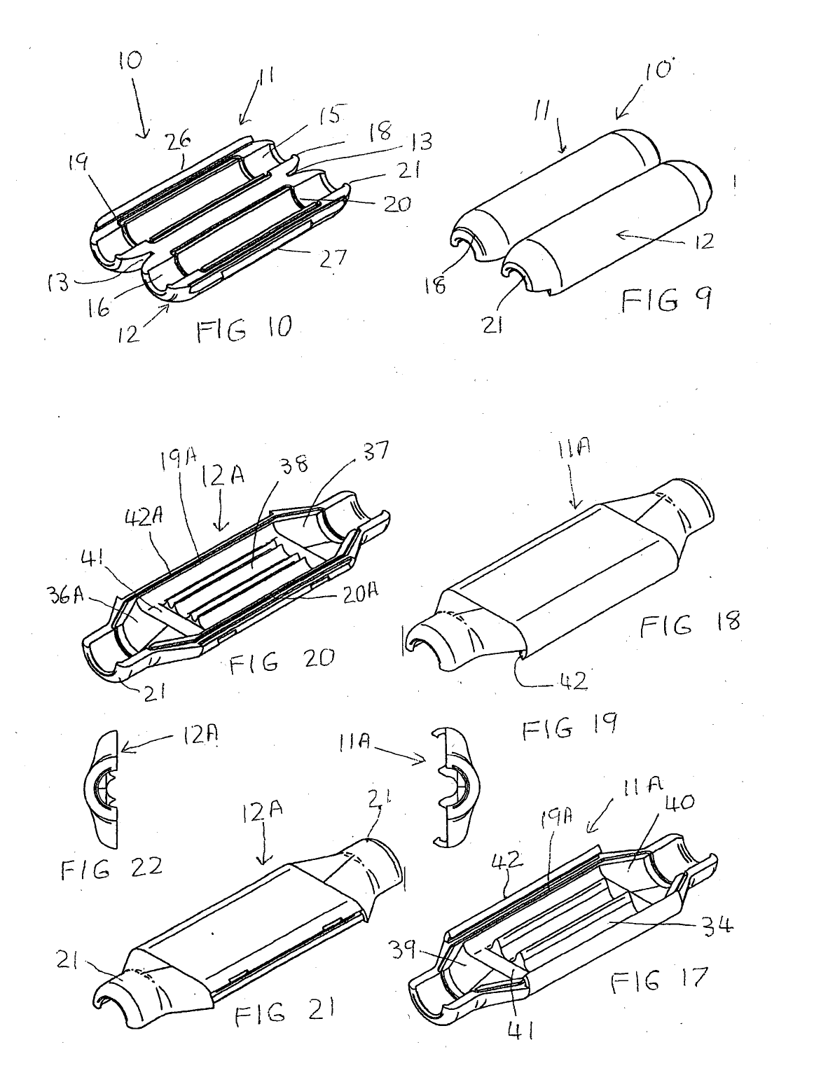

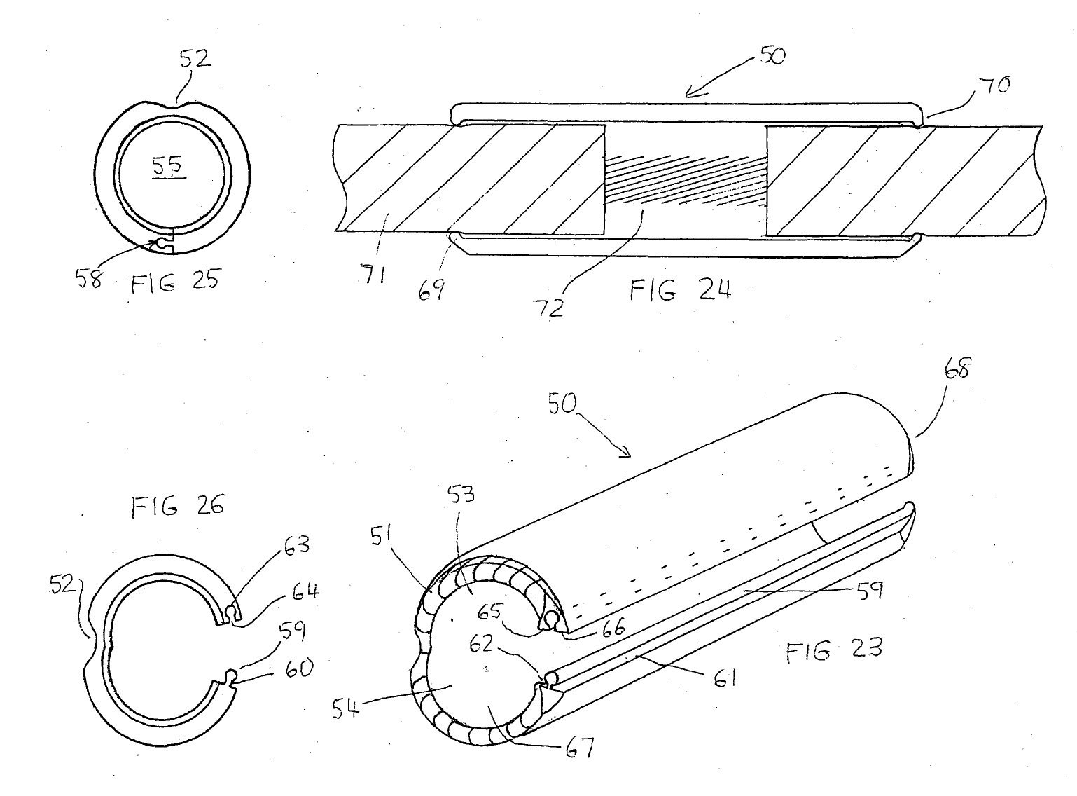

FIG. 2 is a side view of a top component of the cable holder shown in FIG. 1 enclosing the cable;

FIG. 3 is a side view of a bottom component of the cable holder shown in FIG. 1 enclosing the cable;

FIG. 4 is a perspective view of the cable holder shown in FIG. 1;

FIG. 5 is an end view of the cable holder shown in FIG. 1 in a fully open position;

FIG. 6 is a similar view of the cable holder shown in FIG. 5 in a partially open position;

FIG. 7 is a similar view of the cable holder shown in FIG. 5 in a fully closed position;

FIG. 8 is a transverse sectional view of the cable holder shown in FIG. 7;

FIG. 9 is a perspective external view of the cable holder shown in FIG. 1;

FIG. 10 is a perspective internal view of the cable holder shown in FIG. 1;

FIG. 11 is a plan view of a second embodiment of a cable holder of the invention;

FIG. 12 is a longitudinal section through the cable holder of FIG. 11;

FIG. 13 is a side view of the cable holder shown in FIG. 11;

FIG. 14 is an end view of the cable holder shown in FIG. 11;

FIG. 15 is a perspective internal view of the cable holder shown in FIG. 12;

FIG. 16 is a perspective internal view of the cable holder shown in FIG. 11;

FIG. 17 is a perspective view of a male component of the cable holder shown in FIG. 11,

FIG. 18 is a perspective view of the male component shown in FIG. 17;

FIG. 19 is an end view of the male component shown in FIGS. 17-18;

FIG. 20 is a perspective view of the female component of the cable holder shown in FIG. 11;

FIG. 21 is a perspective view of the female component shown in FIG. 20;

FIG. 22 is an end view of the female component shown in FIG. 20;

FIG. 23 is a perspective view of the cable holder of this embodiment;

FIG. 24 is a sectional view of the cable holder shown in FIG. 23 enclosing an insulated cable having, the metal joint described above;

FIG. 25 is an end view of the cable holder of FIG. 23 in a closed position;

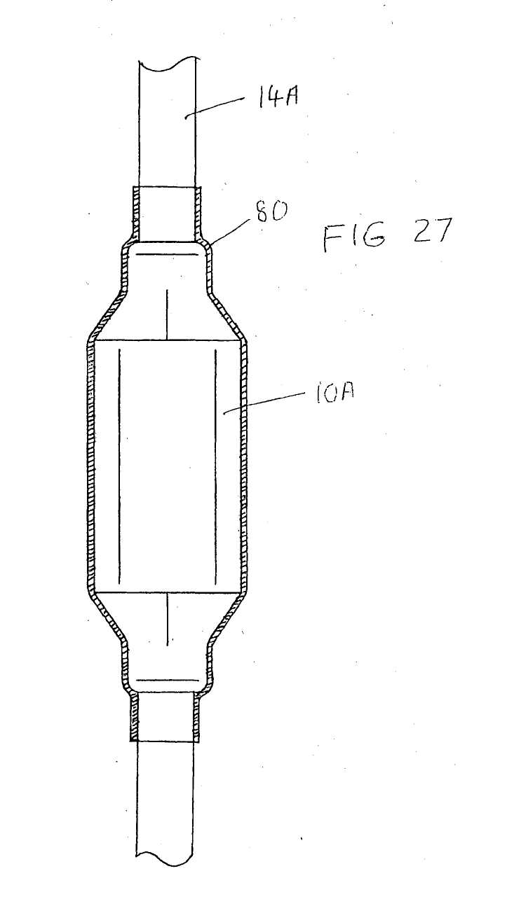

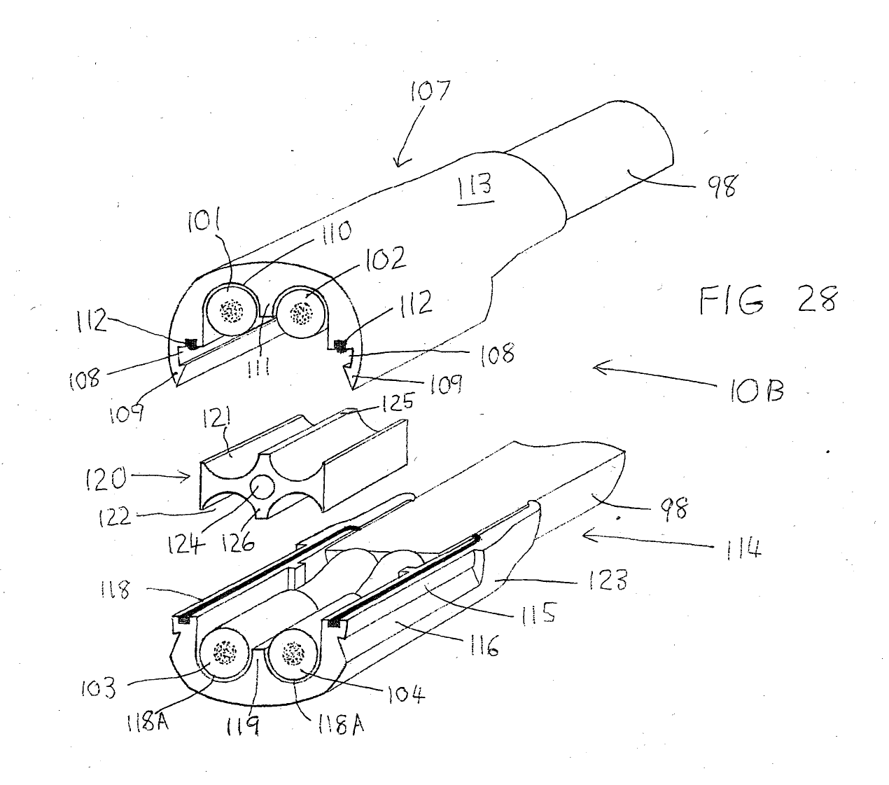

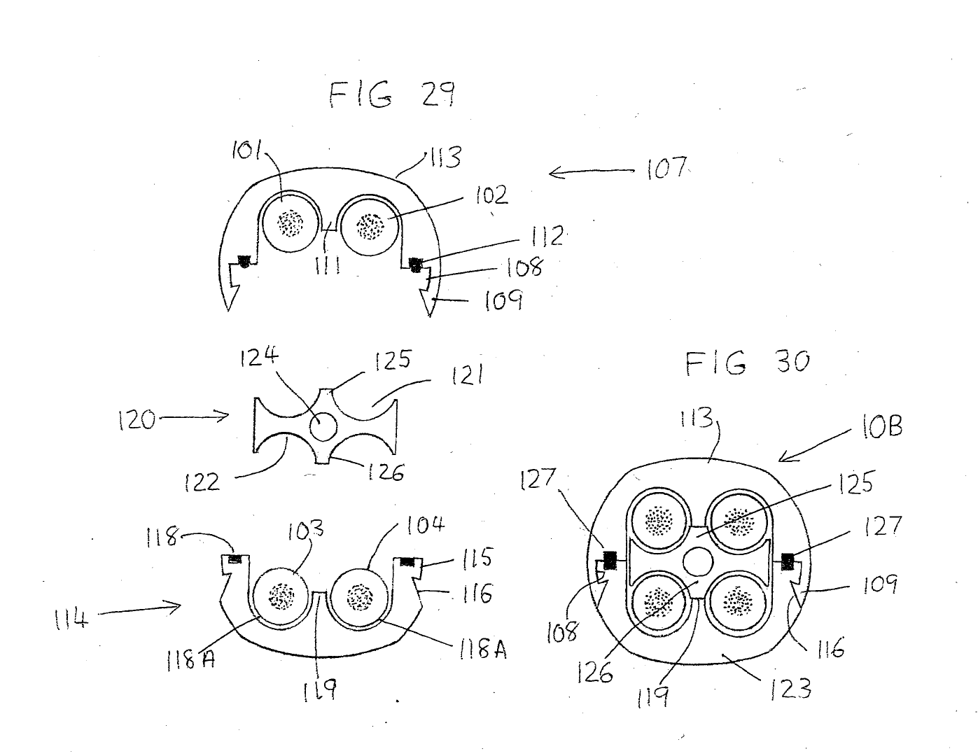

FIG. 26 is an end view of the cable holder of FIG. 23 in an open position;

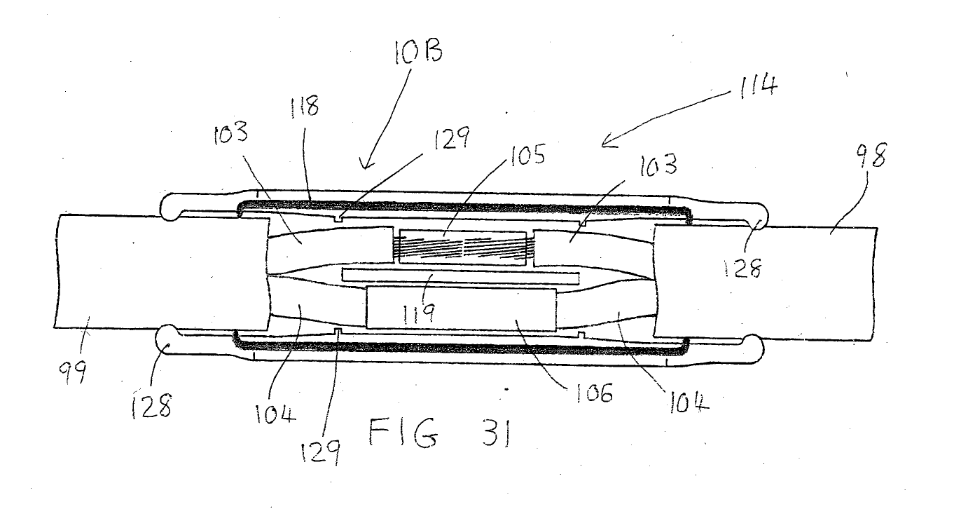

FIG. 27 refers to yet another embodiment of the invention;

FIG. 28 is an exploded view of a cable holder constructed in accordance with this embodiment;

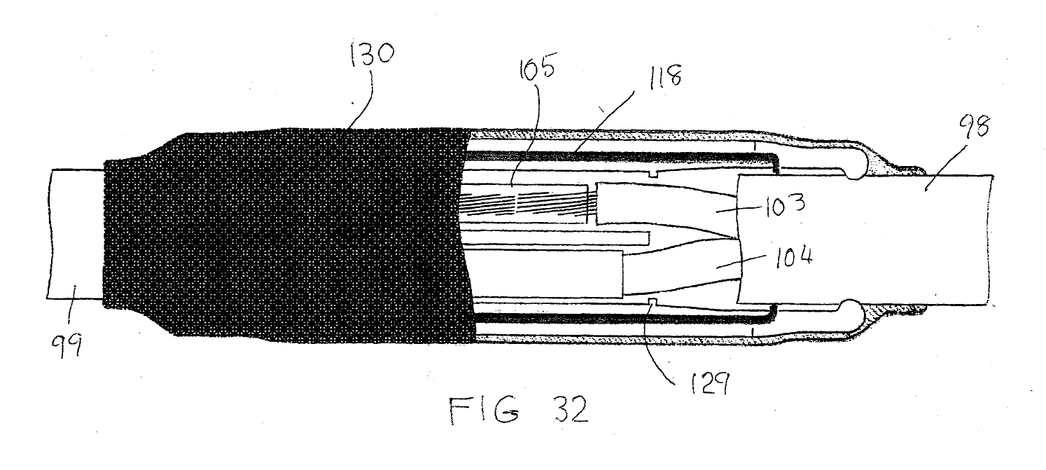

FIG. 29 is a front exploded view of the cable holder shown in FIG. 30;

FIG. 30 is an end view of an assembled cable holder shown in FIGS. 30-31;

FIG. 31 is a longitudinal sectional view of the cable holder shown in FIG. 32; and

FIG. 32 is a similar view to FIG. 33 showing inclusion of a resin lined sleeve.

In the drawings there is shown cable holder 10 shown in FIGS. 1-10 having top component 11 connected to bottom component 12 at 13. There is also provided insulated cable assembly 14 which extends through grooves or channels 15 and 16 in each of components 11 and 12 which enclose insulated cable 14 and cable joint 17 which may be soldered or have a crimped metal sleeve to join adjacent ends of metal wires or conductors of insulated cable assembly 14. Cable joint 17 may interconnect adjacent cable parts 17A. There is also provided moulded strip 19 in top component 11 and bottom moulded strip 20 in bottom component 12 which abut with each other when top component 11 and bottom component 12 are in the closed position as shown in FIG. 8.

Component 11 is provided with inwardly extending parts 18 at each end and bottom component 12 is also provided with inwardly extending parts 21 also at each end which mate with each other to form end sections 23 as shown in FIG. 7. Also each of strips 19 and 20 form a completed moulded strip assembly 24 as shown in FIG. 8. End sections 23 function as a cable grip to ensure secure retention of cable 14 in grooves or channels 15 and 16.

Both moulded strips 19 and 20 are formed from plastics material that is softer than the plastics material forming both top component 11 and bottom component 12 which may be formed from rigid plastics material such as PVC, HDPE or polycarbonate. Both moulded strips 19 and 20 are formed from softer plastics materials such as thermoplastic elastomers and urethanes and are formed by an overmoulding process wherein strips 19 and 20 are formed in the moulding process such as injection moulding as a secondary step in grooves formed in the rigid plastics material in the primary moulding step. It is preferred that at least each part of strips 19 and 20 have an outwardly extending part or projection 25 that ensures a resilient contact between strips 19 and 20 when cable holder 10 as shown is in the closed position as shown in FIG. 8 forming completed moulded strip assembly 24.

It will also be appreciated that top component 11 may be provided with an elongate plug or clip 26 which engages with a corresponding groove or socket 27 best shown in FIG. 5 and FIG. 6.

In FIG. 6 it will be noted that plug or rib 26 has a single small tab 28 or pair of tabs 28 which may engage in a corresponding number of recesses 29 shown in FIG. 4 located in bottom component 12.

In the embodiment of FIGS. 1-10 it will be appreciated that each of components 11 and 12 are interconnected by an integral hinge 13 so that components 11 and 12 are not separated from each other. Hinge 13 may in this arrangement be constituted by a pivot strip or rib or be formed by a pair of mutually adjacent hinge rib sections.

It also will be appreciated in some cases that cable holder 10 may also be Y or T shaped to facilitate a 3-way connection.

However in the embodiment of FIGS. 11-22 it will be appreciated that a cable holder 10A of the invention may be formed from a pair of components 11A and 12A which are separated from each other but which may be attached to each other by plugs engaging with corresponding sockets or by some other form of releasable attachment such as by snap fit or interference fit. This also applies to holder 10 shown in FIGS. 1-10 where any form of suitable releasable attachment means may be utilised.

Thus in relation to the male component 11A shown in FIGS. 17, 18 and 19 such male component 11A has rib 42 which engages with elongate groove 42A of female component 12A shown in FIGS. 20, 21 and 22.

The holder 10A shown in FIGS. 11-22 is suitable for an insulated cable assembly 14A which has a plurality of metal conductors or cables contained therein. Thus in this arrangement each of cables 31, 32 and 33 may be formed by the neutral (N), active (A) or earth (E) lines contained in normal domestic or industrial insulated cables. However it will be appreciated that the number of insulated cables that may be retained by holder 10A can vary from 2-10 for example.

The female component 11A of the holder 10A has three grooves or channels 34 as shown in FIG. 17. There are also provided spaces 36 and 37 for retention of insulated cables 31, 32 and 33 of insulated cable assembly 14A before and after they have passed through grooves or channels 34. Each of cables 31, 32 and 33 have metal parts 31A, 32A and 33A which are cable joints which may be soldered or have a crimped metal sleeve which join adjacent ends of metal wires or cables together. Each metal part 31A, 32A and 33A separate cable adjacent parts 17A. There are also provided cable grips 23 as shown in holder 10 formed by inwardly inclined sections 18 and 21 as also shown in holder 10.

The grooves 34 of male component 11A mate with corresponding grooves 38 of female component 12A shown in FIG. 20 to retain conductors 31, 32 and 33. Male component 11A also has end tapered spaces 39 and 40 which mate with corresponding tapered end spaces 36A and 37. Also provided are planar spaces 41 in each of components 11A and 12A.

Male component 11A also has elongate ribs or clips 42 as shown in FIG. 18 on each side thereof which engage with corresponding grooves 42A of female component 12A as shown in FIG. 20. The connection between rib 42 and groove 42A may be releasable such as by use of a suitable tool such as a screwdriver or alternatively may be a permanent connection.

It will also be appreciated that engagement between separate components 11A and 12A may also occur by snap fit, interference fit or any other form of male-female interaction.

Also shown in both components 11A and 12A are moulded strips 19A and 20A similar to moulded strips 19 and 20 already described in relation to holder 10 which each completely surround channels or grooves 34 which mate with corresponding grooves or channels 38 to form a continuous internal passage or space 23B so as to enclose cables 31, 32 and 33. In a similar manner each of channels or grooves 15 and 16 of cable holder 11 unite upon closure of components 11 and 12 to form an internal passage or space 23A shown in FIG. 8 for cable 14. The provision of moulded strips 19 and 20 in relation to holder 10 and 19A and 20A in regard to holder 10A provide a very simple and efficient method of sealing holders 10 and 10A not shown in the prior art.

From, the foregoing it will be appreciated that cable holder 10 for holding a single insulated cable 14 and cable holder 10A for holding a multiplicity of cables 31, 32 and 33 retain each metal joint 17 or metal joints 31A, 32A and 33A very securely without the need for complicated additional structure as described above for example in relation to U.S. Pat. No. 3,183,302. Thus cable holder 10 or 10A is of very simple structure compared to the prior art.

In FIG. 23 there is provided cable holder 50 having a continuous side wall 51 of constant thickness and a relatively thinner part 52 which functions as a hinge or pivot joint. The cable holder also has a pair of channels 53 and 54 which in the closed position form an inner space 55 surrounded by side wall 51 best shown in FIG. 25. The cable holder 50 may also have a pair of free edges 56 and 57 which are interconnected by an elongate joint or connection 58 which includes an elongate plug or rib 59 of a substantially, round shape as shown in FIGS. 25 and 26 and a support stem 60. There is also provided a pair of substantially flat surfaces 61 and 62 with each surface 61 and 62 bounding each side of support stem 60. The elongate socket or groove 63 is also of round shape to accommodate rib 59. There is also provided a narrow passage 64 which retains support stem 60. There is also provided a pair of substantially flat surfaces 65 and 66 which bound each side of narrow passage 64 and mate with corresponding surfaces 61 and 62 in the closed position as shown in FIG. 25.

The cable holder 50 is also provided with open ends 67 and 68 which are also provided with inwardly extending circumferential ribs 69 and 70 which facilitate engagement with insulated cable 71 as shown in FIG. 24 wherein metal joint 72 is surrounded by internal space 55.

It will be appreciated that support stem 60 and narrow opening 64 may be dispensed with if required. The position of mating flat surfaces 61 and 65 and 62 and 66 provide substantial bearing contact and facilitate retention of plug rib 59 in elongate socket.

It will also be appreciated that cable holder 50 has a multiplicity of features which include joint 58, hinge 52 and ribs 69 and 70 which provide for an extremely effective cable holder 50 in use. Cable holder 50 is also compact and can be used in situations where water ingress is not an issue. Cable holder 50 is also conveniently manufactured by an extrusion process suitable for plastics material.

In another aspect of the invention there is provided a cover sleeve formed from plastics material and which is heat shrink or cold shrink material which is a mechanically expanded extruded plastics tube usually made from nylon or polyolefin which shrinks when heated to return to the relaxed diameter it originally had when extruded. On the other hand cold shrink material is an open ended flexible sleeve made from rubber elastomers with high performance physical properties that have been factory expanded or pre-stretched and assembled onto a supporting removable plastics core. The cold shrink material shrinks upon removal of the core and resulting sleeve or tube can be slid over the cable holder of the invention and removes or unwinds the core causing the tube to contract.

The heat shrink or cold shrink material, with or without a resin lining, may be placed over the cable holder of the invention as shown for example in FIGS. 11-19 which also extends to include the cable insulation itself. This is shown in FIG. 27 which shows the plastics sleeve 80 fully covering the cable holder 10A. Such a sleeve is extremely useful to enhance the ingress protection of the cable holder 10A.

It will further be appreciated that the sleeve 80 may be used to cover cable holder 10 shown in FIGS. 1-10 as well as cable holder 50 shown in FIGS. 23-26.

The plastics sleeve 80 may be used in combination with the overmoulding strips 19 and 20 shown in FIGS. 1-10 or overmoulding strips 19A and 20 shown in FIGS. 11-19 or without such overmoulding strips as in the case of the cable holder shown in FIGS. 23-26.

In FIGS. 28-32 there is shown cable holder 10B holding or connecting adjacent insulated cable assemblies 98 and 99 each carrying insulated cables 101, 102, 103 and 104. Each of these insulated cables have a crimped metal joining sleeve 105, as shown in FIG. 31, each having a resin lined shrink wrap 106 also shown in FIG. 31.

In FIG. 28 there is provided a top cable joiner component 107 provided with a pair of longitudinal slots 108 and a pair of adjacent tapered ends 109 as well as a pair of conductor retaining passages 110 separated by an intermediate rib 111. There is also provided a pair of overmoulded sealing strips 112. The top joiner component 107 is also provided with a body 113.

There is also shown a bottom cable joiner component 114 having a pair of longitudinal ribs 115 which each engage a corresponding slot 108 as shown in FIG. 32. Bottom joiner component 114 has a pair of tapered longitudinal slots 116 which each engage with a mating tapered end 109 of top component 107 as shown in FIG. 32. Bottom component 114 also has a pair of overmoulded sealing strips 118 which engage with mating sealing strips 112 also as shown in FIG. 31. Bottom component 114 also has a pair of conductor retaining passages 118A each enclosing conductors 103 and 104 separated by intermediate rib 119. Bottom component 114 also has body 123.

A feature of this embodiment is the provision of a partition or divider component 120 having a pair of top channels 121 and a pair of bottom channels 122 as well as a central elongate opening 124. Component 120 is also provided with a top central rib 125 and a bottom central rib 126. In FIG. 30 it will be appreciated that rib 125 abuts with rib 111 and rib 126 abuts rib 119.

In FIG. 30 mating sealing strips 112 and 118 form a complete sealing strip 127.

In FIG. 31 there is also shown end grips 128 which facilitate attachment of cable holder 10B to insulated cable assemblies 98 and 99 as well as locating lugs 129 for retention of partition component 120.

FIG. 32 shows a similar view to FIG. 31 showing the incorporation of resin lined sleeve 130 which covers cable holder 10B in its entirety and is useful in retaining cable holder 10B in its desired position in regard to insulated cables 98 and 99.

The main feature of the embodiment shown in FIGS. 28-32 is the provision of a partition component or divider component 120 which effectively provides a cable holder which can effectively hold 3-6 conductors which may be included in a single insulated cable. The function of the partition component is to effectively separate each conductor from each other in the insulated cable and especially a crimped metal sleeve or soldered joint may interconnect each conductor as exemplified by metal joint 105 shown in FIG. 31.

Another feature of this embodiment is to use a resin lined shrink wrap so that it is wrapped around the metal joint 105. This is shown by sleeve 106 which may be formed from a polyolefin heat shrink wrap that also may be adhesive lined or be formed from fabric shrink tubing. Heat shrink or heat wrap tubing may also be formed from chlorinated polyolefin or highly flexible elastomer. PVC, PTFE and fluoropolymer may also be used. Examples of suitable resin from a fluoropolymer are polyvinylidene fluoride or PVDF.

The partition component 120 also provides a cable holder which has robust strength and extreme ingress protection especially when used with an outer covering or sheath 130 formed from resin lined shrink wrap formed from the materials described above.

The outer sheath 130 is also useful in that when shrunk by heat it also seals any gaps which may occur in cable holder 10B, e.g. as shown in FIG. 30 where sheath 130 may penetrate into any gaps formed between abutting surfaces or ribs 116 and 109.

1. A cable holder useful for holding a single insulated cable assembly or a multiplicity of insulated cable assemblies wherein the cable holder comprises; a pair of components attached or integral with each other so as to form a sheath or sleeve for containing the cable assembly or cable assemblies wherein adjacent metal ends of adjoining cable parts are interconnected by a metal joint whereby when the holder is in a closed position there is provided an internal space formed by mutually adjoining channels wherein (i) the or each internal space has a diameter that is substantially the same as each insulated cable part located proximal to said metal joint and said metal joint has a diameter or lateral dimension which is smaller than a diameter or transverse dimension of the or each internal space and the or each internal space does not include any sealing arrangement; or (ii) there is provided a sealing rib or gasket which completely surrounds each channel wherein when the cable holder is in a closed position adjacent sealing ribs are in abutment with each other whereby each sealing rib is formed by an overmoulding process whereby each rib is formed at least partly from a softer plastics material than a plastic material forming a body of the cable holder.

2. The cable holder as claimed in claim 1 wherein the or each internal space has a diameter that is substantially the same as each insulated cable part located proximal to said metal joint and said metal joint has a diameter or lateral dimension which is smaller than a diameter or transverse dimension of the or each internal space and the or each internal space does not include any sealing arrangement.

3. A The cable holder as claimed in claim 1 wherein there is provided a sealing rib or gasket which completely surrounds each channel wherein when the cable holder is in a closed position adjacent sealing ribs are in abutment with each other whereby each sealing rib is formed by an over overmoulding process whereby each rib is formed at least partly from a softer plastics material than the plastics material forming a body of the cable holder.

4. The cable holder as claimed in claim 1 wherein each component is attached to each other by a hinge integral with each component.

5. The cable holder as claimed in claim 1 each component is completely separate from each other and releasably attachable to each other.

6. The cable holder also claimed in claim 5 wherein each component is releasably attachable to each other by a longitudinal rib engaging a longitudinal recess or groove.

7. The cable holder as claimed in claim 2 wherein each component has three mating channels so that when each component is in a closed position the cable holder may retain a plurality of cables each having a neutral (N) active (A), or earth (E) conductor.

8. The cable holder as claimed in claim 2 wherein each component has only one channel wherein when each channel mates with each other to form a single insulated space for retention of an adjacent insulated cable.

9. The cable holder as claimed in claim 8 wherein each end of the cable holder is provided at each end with an inwardly extending circumferential rib which engages with the adjacent insulated cable.

10. A The cable holder as claimed in claim 1 wherein each end of the cable holder is provided with an inwardly extending circumferential rib to engage with an adjacent insulated cable or multiplicity of adjacent insulated cables.

11. The cable holder as claimed in claim 1 wherein the cable holder is provided with a cover sleeve formed from heat shrink or cold shrink material.

12. The cable holder as claimed in claim 3 wherein cable holder has a top cable joiner component having a plurality of channels of wherein each channel retains at least part of a proximal insulated cable in use and there is also provided a bottom joiner component also having a plurality of channels wherein each channel retains at least part of a proximal insulated cable in use and there is also provided a partition component having a multiplicity of top grooves and a multiplicity of bottom grooves whereby when said partition component is in abutment with the top cable joiner component and the bottom cable joiner component there is provided a series of passages for retaining a respective insulated cable formed by adjoining pairs of each adjacent top cable joiner channel and top groove and each adjacent bottom cable joiner channel and bottom groove.

13. The cable holder as claimed in claim 3 wherein the or each internal space has a diameter or lateral dimension which is substantially the same as each insulated cable part.
